(19) United States
(12) Patent Application Publication
(10) Pub. No.: US 2010/0122779 A1
(43) Pub. Date: May 20, 2010

(54) VENETIAN BLIND

(76) Inventor: Chin-Fu Chen, Taichung (TW)

Correspondence Address: BROWDY AND NEIMARK, P.L.L.C.;624 NINTH STREET, NW, SUITE 300, WASHINGTON, DC, 20001-5303, US

(21) Appl. No.: 12/361,207

(22) Filed: Jan. 28, 2009

(30) Foreign Application Priority Data
Nov. 17, 2008 (TW) 97220581

(51) Int. Cl. E06B 9/382

(52) U.S. Cl. 160/168.1 V

(57) ABSTRACT

A venetian blind includes a rotatable upper beam, a plurality of slats, two ladder tapes connected with two opposite sides of the slats and each having a top end fixed to the upper beam, and two cords each having a top end connected with the upper beam to drive the upper beam to rotate in opposite directions such that the slats can be forced by the ladder tapes to rotate through the rotation of the upper beam, thereby allowing the light to pass through or blocking the light.

### BACKGROUND OF THE INVENTION

1. Field of the Invention

The present invention relates generally to a venetian blind, and more specifically to a venetian blind that has a simple structure and a low manufacturing cost.

2. Description of the Related Art

FIG. 1 shows a conventional venetian blind 10 comprising an upper beam 11, two retainers 12 mounted to the upper beam 11, four ladder tapes 13 connected to the retainers 12 in pairs, a plurality of slats 14 connected to the ladder tapes 13, an adjuster 15 mounted to the upper beam 11, a cord 16 connected to the adjuster 15, and a driving rod 17 passing through the retainers 12 and the adjuster 15.

Referring to FIG. 1A, when a user pulls the cord 16 downward, an inner gear of the adjuster 15 can be rotated to force the retainers 12 to rotate synchronously through the driving rod 17, such that the slats 14 can be driven by the retainers 12 to rotate through the ladder tapes 13, thereby attaining the purpose of adjusting the light.

As described above, the conventional venetian blind 10 needs to be equipped with many components, such as the retainers 12, the adjuster 15 and the driving rod 17, for rotation of the slats 14, so it can be seen that the conventional venetian blind 10 has the drawbacks of having complicated structure and high manufacturing cost.

### SUMMARY OF THE INVENTION

The present invention has been accomplished in view of the above-noted circumstances. It is one objective of the present invention to provide a venetian blind that has a simple structure and a low manufacturing cost.

To achieve this objective of the present invention, the venetian blind comprises a rotatable upper beam, a plurality of slats, two ladder tapes connected with two opposite sides of the slats and each having a top end fixed to the upper beam, and two cords each having a top end connected with the upper beam to drive the upper beam to rotate in opposite directions.

When one of the cords is pulled, the upper beam can be rotated clockwise to force the slats to rotate through the ladder tapes, thereby blocking the light. When the other one of the cords is pulled, the upper beam can be rotated counterclockwise to drive the slats to rotate, thereby allowing the light to pass between the slats.

Accordingly, the venetian blind of the present invention uses a simple structure to control the rotation of the slats so as to reduce the manufacturing cost, thereby achieving the objective of the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a venetian blind according to a prior art;

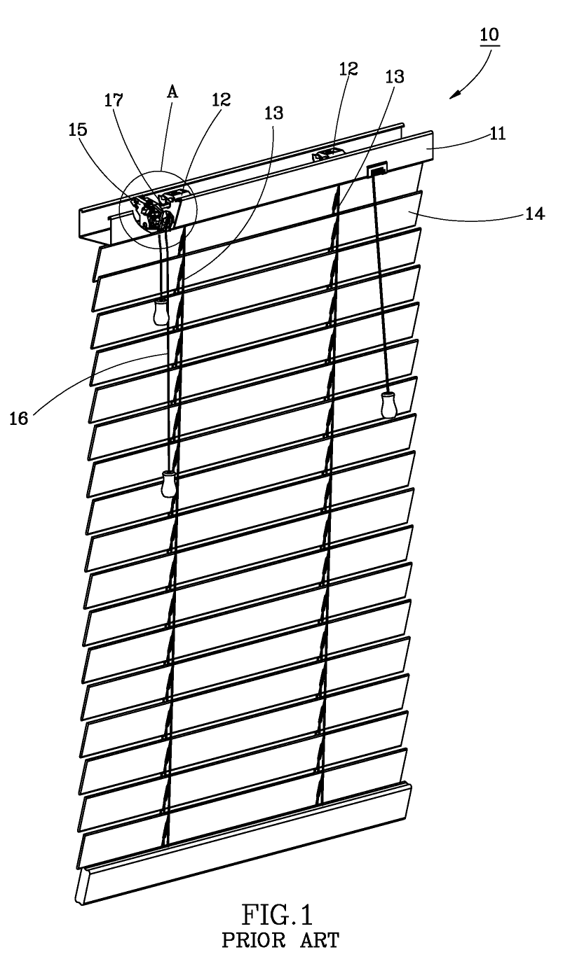

FIG. 1A is an enlarged view of a portion encircled by circle A in FIG. 1;

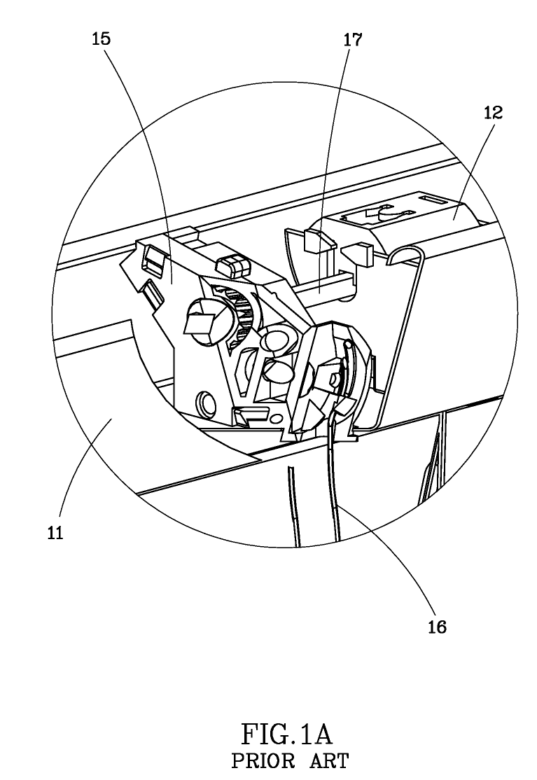

FIG. 2 is a partially exploded view of a venetian blind according to a preferred embodiment of the present invention;

FIG. 3 is an exploded view of the left bracket and the upper beam of the venetian blind according to the preferred embodiment of the present invention;

FIG. 4 is a perspective view of the venetian blind according to the preferred embodiment of the present invention, showing that the slats are rotated to allow the light to pass through;

FIG. 5 is another perspective view of the venetian blind according to the preferred embodiment of the present invention, showing that the slats are rotated to block the light, and

FIG. 6 is a perspective view of the venetian blind according to the preferred embodiment of the present invention, showing that the slats are overlapped.

### DETAILED DESCRIPTION OF THE INVENTION

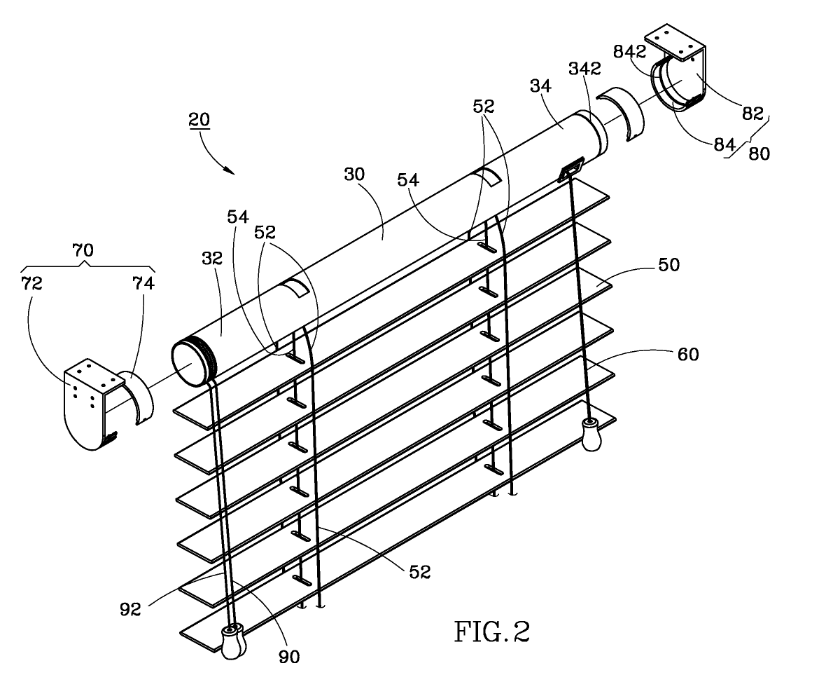

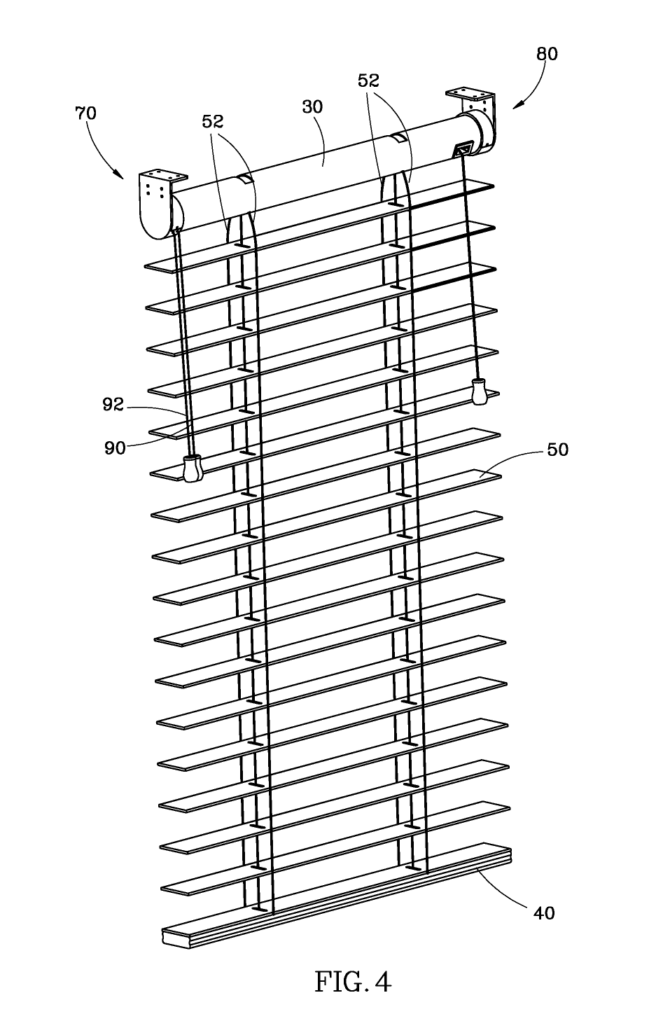

As shown in FIGS. 2 and 4, a venetian blind 20 in accordance with a preferred embodiment of the present invention comprises an upper beam 30, a lower beam 40, a plurality of slats 50, two pairs of ladder tapes 52, a lifting cord 60, a left bracket 70, a right bracket 80, a first light-adjusting cord 90, and a second light-adjusting cord 92.

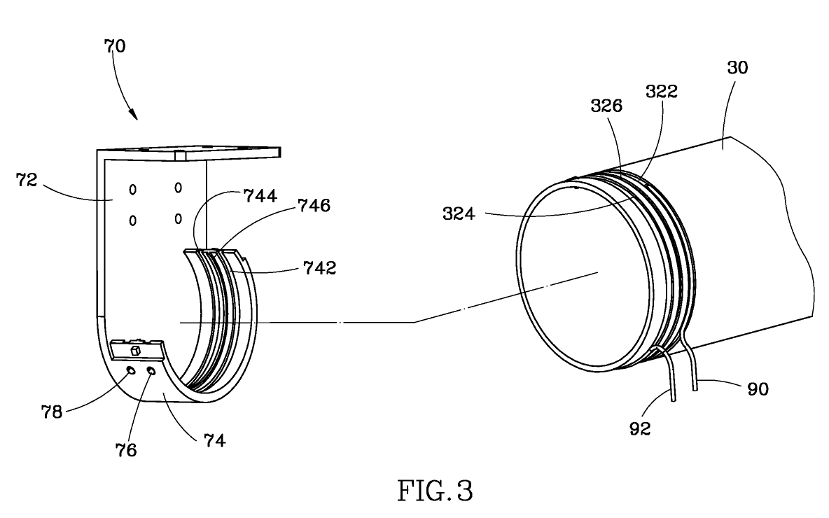

As shown in FIGS. 2 and 3, the upper beam 30 has, but not limited to, a circular crosssection. The upper beam 30 has a left end portion 32, two first grooves 322 and 324 at an outer periphery of the left end portion 32, a left recess 326 between the first grooves 322 and 324, a right end portion 34, and a right recess 342 at an outer periphery of the right end portion 34.

The lower beam 40 has, but not limited to, a rectangular crosssection. The lower beam 40 is located under the upper beam 30.

The slats 50 are spacedly suspended between the upper beam 30 and the lower beam 40 by means of the ladder tapes 52 and strips 54 passing though the slats 50.

The ladder tapes 52 are connected with two opposite sides of the slats 50, and respectively provided with a top end fixed to the upper beam 30 and a bottom end fixed to the lower beam 40.

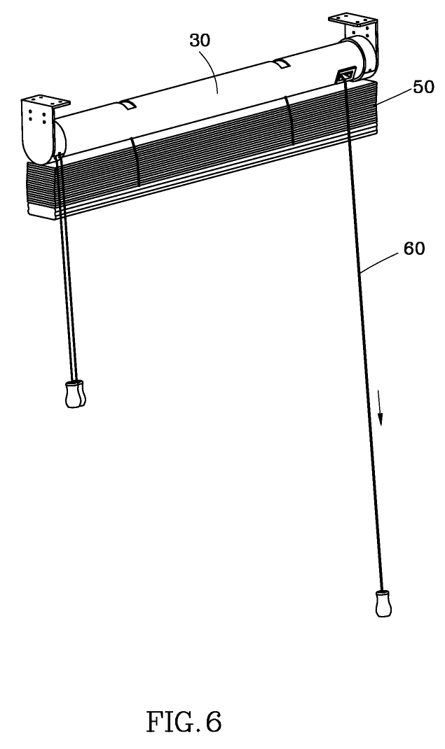

The lifting cord 60 has a top end penetrating into the upper beam 30 and connected with a pulley device (not shown) in the upper beam 30, and a bottom end suspended downward. By means of pulling the bottom end of the lifting cord 60, the slats 50 can be lifted upward to overlap each other through the pulley device, as shown in FIG. 6.

As shown in FIG. 3, the left bracket 70 includes a left bracket base 72 capable of fastening to a wall or a window frame, and a left bracket cover 74 having two second grooves 742 and 744 at an inner periphery thereof, a left protrusion 746 between the second grooves 742 and 744, a first through hole 76, and a second through hole 78. When the left bracket 70 is assembled to the left end portion 32 of the upper beam 30, the left protrusion 746 of the left bracket cover 74 is engaged with the left recess 326 of the upper beam 30, and the second grooves 722 and 744 of the left bracket cover 74 are respectively corresponding to the first grooves 322 and 324 of the upper beam 30.

The right bracket 80 includes a right bracket base 82 capable of fastening to the wall or the window frame, and a right bracket cover 84 having a right protrusion 842 at an inner periphery thereof. When the right bracket 80 is assembled to the right end portion 34 of the upper beam 30, the right protrusion 842 of the right bracket cover 84 is engaged with the right recess 342 of the upper beam 30.

The first light-adjusting cord 90 is wound around the left end portion 32 of the upper beam 30 clockwise along the first groove 322 of the upper beam 30 and the second groove 742 of the left bracket cover 74, and provided with a top end fixed to the left end portion 32 of the upper beam 30 and a bottom end passing through the first through hole 76 of the left bracket cover 74 to be suspended downward. Therefore, when the bottom end of the first light-adjusting cord 90 is pulled, the upper beam 30 can be rotated clockwise.

The second light-adjusting cord 92 is wound around the left end portion 32 of the upper beam 30 counterclockwise along the first groove 324 of the upper beam 30 and the second groove 744 of the left bracket cover 74, and provided with a top end fixed to the left end portion 32 of the upper beam 30 and a bottom end passing through the second through hole 78 of the left bracket cover 74 to be suspended downward, such that the upper beam 30 can be rotated counterclockwise by pulling the bottom end of the second light-adjusting cord 92.

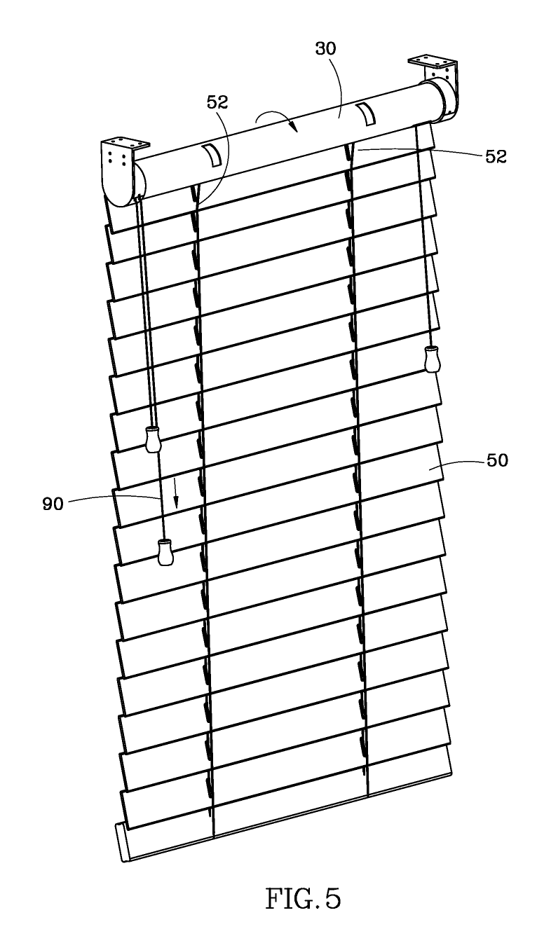

When a user pulls the first light-adjusting cord 90, the upper beam 30 can be rotated clockwise to force the slats 50 to rotate through the ladder tapes 52, as shown in FIG. 5, and when the pulling force is released, the upper beam 30 can stop rotating by means of the friction force generated between the left and right protrusions 746 and 842 and the left and right recesses 326 and 342 for enabling the slats 50 to tilt to one side, thereby blocking the light. Thereafter, when the user pulls the second light-adjusting cord 92 to drive the upper beam 50 to rotate counterclockwise, the slats 50 can be forced to rotate for allowing the light to pass through, as shown in FIG. 4.

Besides, when the user pulls the lifting cord 60, the lower beam 40 can move upward to cause the slats 50 to overlap each other through the gear device in the upper beam 30.

Compared to the conventional venetian blind of the prior art, the venetian blind of the present invention provides two light-adjusting cords and the rotatable upper beam to control the rotation of the slats without installing complicated components, such as the adjuster, the retainers, and the driving rod, so that the venetian blind of the present invention has the advantages of having simple structure and low manufacturing cost.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A venetian blind comprising:
an upper beam that is rotatable;
a plurality of slats;
two ladder tapes connected with two opposite sides of said slats and each having a top end fixed to said upper beam; and
two cords each having a top end connected with said upper beam to drive said upper beam to rotate in opposite directions such that said slats can be forced by said ladder tapes to rotate through the rotation of said upper beam.

2. The venetian blind as claimed in claim 1, further comprising a bracket mounted to an end portion of said upper beam and provided with two through holes for penetration of said cords.

3. The venetian blind as claimed in claim 2, wherein said upper beam has two first grooves at said end potion thereof, and said bracket has two second grooves, each of which is corresponding to one of said first grooves of said upper beam; said cords each pass through one of said first grooves of said upper beam and one of said second grooves of said bracket.

4. The venetian blind as claimed in claim 2, wherein said bracket has a protrusion, and said upper beam has a recess at said end portion thereof for insertion of said protrusion.

5. The venetian blind as claimed in claim 1, wherein said upper beam has a circular crosssection.
